(19) United States
(12) Patent Application Publication
(10) Pub. No.: US 2018/0056393 A1
(43) Pub. Date: Mar. 1, 2018

(54) SYSTEM FOR ADDITIVE MANUFACTURING OF THREE-DIMENSIONAL OBJECTS

(71) Applicant: CL SCHUTZRECHTSVERWALTUNGS GMBH, Lichtenfels (DE)

(72) Inventors: Frank Herzog, Lichtenfels (DE); Florian Bechmann, Lichtenfels (DE); Philipp Schumann, Itzgrund - Schottenstein (DE)

(73) Assignee: CL SCHUTZRECHTSVERWALTUNGS GMBH, Lichtenfels (DE)

(21) Appl. No.: 15/687,375

(22) Filed: Aug. 25, 2017

(30) Foreign Application Priority Data
Aug. 25, 2016 (DE) 102016115846.1

(51) Int. Cl. B22F 3/105; B33Y 30/00; B33Y 50/02

(52) U.S. Cl. CPC B22F 3/1055; B33Y 30/00; B22F 2003/1057; B22F 2003/1056; B33Y 50/02

(57) ABSTRACT

A system (1) for additive manufacturing of three-dimensional objects, comprising:
at least one apparatus (3) provided for additive manufacturing of a three-dimensional object (2) by successive, selective layer-by-layer exposure and thus solidification of construction material layers to be selectively solidified by means of an energy beam (5),
at least one powder module (11a-11c) comprising a powder chamber limiting a powder chamber volume for receiving construction material (4) to be solidified within the scope of an additive construction process or not solidified within the scope of an additive construction process with a carrying device (12a-12c) arranged or formed therein comprising at least one magnetizable component,
at least one demagnetization device (14) provided for automatable or automated demagnetization of at least one magnetized component of the powder module (11a-11c), especially the carrying device (12a-12c).

The invention relates to a system for additive manufacturing of three-dimensional objects.

Such systems for additive or generative manufacturing of three-dimensional objects are actually known. Respective systems comprise, among other things, apparatuses for additive manufacturing of three-dimensional objects. The three-dimensional objects to be additively manufactured are manufactured by means of respective apparatuses. The use of powder modules in respective systems is known. Respective powder modules typically comprise a powder chamber limiting a powder chamber volume for receiving construction material to be solidified within the scope of an additive construction process or not solidified within the scope of an additive construction process. Respective powder chambers are typically limited at the bottom by a carrying device. Respective powder modules typically comprise at least one magnetizable component.

For additive manufacturing, an (as) complete (as possible) demagnetization of respective magnetizable components of the powder modules is desired. Magnetization of respective magnetizable components has a negative effect on, for example, coating processes for forming construction material layers to be selectively solidified and quality assurance processes, as magnetization can cause a specific orientation of the construction material particles, which causes undesired scattering of the ambient light, which, in turn, can impair, for example, a camera-based examination of the construction material.

To date, time-consuming manual demagnetization has been necessary.

There is a consistent need for development of respective systems with regard to the partially or fully automatable demagnetization of respective magnetizable components.

The invention is based on the object to provide, in contrast to the above, especially with regard to a partially or fully automatable demagnetization of respective magnetizable components, an improved system for additive manufacturing of three-dimensional objects.

The object is solved by a system for additive manufacturing of three-dimensional objects according to claim 1. The dependent claims relate to special embodiments of the system.

The system described herein generally serves for additive or generative manufacturing of three-dimensional objects, i.e., for example, technical components or technical component groups.

The system comprises at least one apparatus (hereinafter, in short, referred to as “apparatus”) for additive manufacturing of at least one three-dimensional object (hereinafter, in short, referred to as “object”) by successive, selective layer-by-layer exposure and thus solidification of construction material layers to be selectively solidified of a construction material that can be solidified by means of at least one energy beam. The construction material that can be solidified may be metal powder, plastic powder, and/or ceramic powder. A metal powder, plastic powder or ceramic powder can also mean a powder mixture of different metals, plastics, or ceramics. Therefore, a metal powder can also be a powder of a metal alloy. The energy beam can be a laser beam. The apparatus can respectively be an SLM apparatus for performing selective laser melting methods (SLM methods in short) or an SLS apparatus for performing selective laser sintering methods (SLS methods in short). The system can respectively be a system for performing selective laser melting methods or a system for performing selective laser sintering methods.

The successive, selective layer-by-layer exposure and thus successive, selective layer-by-layer solidification of the construction material layers to be solidified respectively for additive manufacturing of an object is performed based on object-related construction data. The construction data generally describe the geometric or geometric structural design of the object to be manufactured additively. The construction data can be or contain, for example, CAD data of the object to be manufactured.

The apparatus comprises all functional components typically required to perform additive construction processes. Respective components are, for example, a coating device for forming construction material layers to be selectively exposed in a construction plane and an exposure device comprising one or more exposure elements, for example, formed as or comprising laser diode elements, for generating an energy beam for selective exposure of a construction material layer formed in a construction plane by means of the coating device to be selectively exposed and thus selectively solidified. The functional components are typically arranged in a housing structure of the apparatus, possibly also to be referred to or considered as machine housing, which can typically be rendered inert.

The system furthermore comprises at least one powder module. The powder module can generally be any powder module provided for receiving and/or dispensing construction material. The powder module can especially be a construction module in which the actual additive construction of three-dimensional objects is performed and which is for this purpose filled successively and in layers with construction material to be selectively solidified in the course of additive manufacturing processes, a metering module via which construction material is metered out into a process chamber successively and in layers in the course of additive manufacturing processes, or a collector module which is filled with construction material that is not solidified in the course of additive manufacturing processes.

The powder module comprises a powder chamber for receiving construction material to be selectively solidified within the scope of an additive construction process or construction material not solidified within the scope of an additive construction process. The powder chamber limits a powder chamber volume that can be filled with construction material. The powder chamber volume is limited at least on the sides by walls (powder chamber walls) of the powder chamber generally formed like a hollow cuboid or hollow cylinder. At the bottom, the powder chamber volume is limited by a carrying device.

The carrying device is typically movably supported between two end positions, i.e., between an upper end position (related to the height of the powder module) and a lower end position (related to the height of the powder module), relative to the powder chamber. The movable support of the carrying device allows for realizing an, especially linear, movement of the carrying device along a vertical movement axis or in a vertical direction of movement. The movable support of the carrying device is realized with a drive device coupled to said carrying device. The drive device is provided for forming or generating a force (driving force) setting the carrying device in a respective motion relative to the powder chamber. The drive device can, e.g., be formed (electro)mechanically, hydraulically, or pneumatically.

The powder module comprises several components, including, e.g., the already mentioned carrying device. The carrying device comprises several components as well, including, e.g., a table-like base body and one or more plate-like or plate-shaped supporting bodies arranged or formed, especially stack-like, on the base body. Respective supporting bodies can be functionalized differently. Respective supporting bodies can be, for example, a construction plate, a heating plate, or a (thermal) insulating plate. At least one of the mentioned components of the powder module, especially the carrying device, is magnetizable, for example, because of being formed of a magnetizable material such as ferritic steel. A magnetizable component of the carrying device is especially but not necessarily the mentioned construction plate.

With regard to the problem of magnetization of respective magnetic components of the powder modules mentioned at the beginning, especially the carrying devices associated with the powder modules, the system comprises at least one demagnetization device. The demagnetization device is provided for automatable or automated demagnetization of a magnetized component of the powder module, especially the carrying device. It is thus possible to perform demagnetization processes automatably or automatedly. The time-consuming manual performance of respective demagnetization processes, in which a user manually runs a demagnetization device along the component to be demagnetized, is no longer necessary. Consequently, an improved system for additive manufacturing of objects is provided.

As shown in the following, the demagnetization device can be a workstation inside the system provided with its own functionality—namely the demagnetization of respective components of a powder module. The demagnetization device can hence form a demagnetization station. Additional workstations inside the system can be, for example, construction or process stations formed by respective apparatuses in which the actual additive manufacturing of the objects is performed, unpacking stations in which “unpacking” of additively manufactured objects from the surrounding construction material is performed, or filling stations in which filling or emptying of respective powder modules is performed.

The demagnetization device can comprise at least one detection unit provided for detecting the magnetization of a magnetized component of the powder module, especially the carrying device. A respective detection unit is typically provided for generating detection information (detection result) describing the magnetization of the at least one magnetized component of the powder module. A respective detection unit allows an exact detection of the magnetization, i.e., especially the (local or global) degree of magnetization, any (local or global) magnetization gradients, of a magnetized component of the powder module. Knowledge of the magnetization of a magnetized component typically allow an efficient demagnetization of the component. The detection unit can be formed as or at least comprise a magnetometer (Gauss or Tesla meter).

The demagnetization device can furthermore comprise at least one demagnetization unit provided for demagnetizing the at least one magnetized component of the powder module, especially the carrying device. The demagnetization unit is provided for performing at least one measure for demagnetization of a magnetized component of the powder module. The measure can be the generation of a demagnetizing field. The demagnetizing field is typically a static or dynamic alternating magnetic field. The demagnetization unit can hence be provided for generating a respective demagnetizing field and comprise the demagnetization elements required for that, such as demagnetization coils.

The system can furthermore comprise a control device provided for controlling the operation of the at least one demagnetization unit dependent on or on the basis of detection information describing the magnetization of the at least one magnetized component of the powder module, especially the carrying device. The control device implemented by hardware and/or software, typically data-coupled with the detection unit and demagnetization unit, can hence be provided for generating, with regard to a concrete magnetized component of a powder module to be demagnetized, individually generated control information, which allows for a particularly efficient demagnetization of the component of the powder module to be demagnetized.

The demagnetization device can comprise a receiving room for receiving a powder module to be demagnetized, especially a magnetized component of the carrying device. In the receiving room, an inert atmosphere, especially an inert gas atmosphere, i.e., for example, an argon or nitrogen atmosphere, is or can be formed. The receiving room can be magnetically shielded (outwards).

The powder module can be movable and thus moved in or inside the system, especially between respective workstations. Hence, the powder module can, for example, be moved to the demagnetization device (“demagnetization station”) to demagnetize a component of the powder module to be demagnetized, especially the carrying device. For moving the powder module, it can be equipped, for example, with wheels or rolls. Moving the powder module inside an (optional) tunnel structure associated with the system is explained further below. Analogously, it is, of course, also imaginable that the demagnetization device is movable and can thus be moved in or inside the system, especially between respective workstations.

The system can comprise a tunnel structure. The tunnel structure typically connects at least two workstations of the system with each other. The tunnel structure provides at least one, especially tunnel tube-like or tube-shaped, tunnel section in or through which at least one powder module can be moved. The tunnel section typically extends between at least two workstations of the system. In a respective tunnel section, at least one movement path or track (hereinafter “movement path”) is formed or arranged along which a powder module can be moved through the tunnel section. Of course, it is possible to form or arrange in a tunnel section at least sectionally several movement paths, i.e., for example, movement paths arranged adjacently, especially in parallel, at one or more level(s). A respective movement path can allow guided movement of a powder module in or through the respective tunnel section.

The function of the tunnel structure or the associated tunnel section is, as mentioned, to connect at least two different workstations of the system directly or indirectly, i.e., for example, by interconnecting at least one more tunnel section and/or one more workstation of the system. The connection of respective workstations of the system allows for moving back and forth respective powder modules between respective workstations of the system. Moving respective powder modules through the tunnel structure is especially possible in a fully automated way. Via one or more tunnel section(s), for example, a construction or process station associated with the system can be connected with an unpacking or filling station associated with the system.

It is generally possible that the movement path along which a powder module is moved from a first workstation of the system back to another workstation of the system is different from the movement path along which the powder module was moved from the first workstation to the other workstation. The movement path of a powder module between respective workstations of the system can be chosen on the basis of certain prioritizations of certain powder modules. For higher-prioritized powder modules, shorter movement paths as regards distance or time can be chosen than for lower-prioritized powder modules. Similarly, higher-prioritized powder modules can be moved with a higher speed compared to lower-prioritized powder modules.

For moving respective powder modules, the system comprises at least one conveyor device. The conveyor device can be coupled with a (motorized) drive device via which a driving force can be generated that sets at least one powder module in motion.

The conveyor device can comprise at least one conveyor means arranged or formed on the tunnel structure provided for setting a powder module in motion. Such a conveyor means can be, for example, a mechanical conveyor means, i.e., for example, a belt, chain, or roll conveyor, which defines, due to its extension inside a respective tunnel section, a conveyor line and thus a movement path along which a powder module can be moved. A respective conveyor means can, for example, be arranged or formed on the floor or wall of a tunnel section.

The or a conveyor device can comprise at least one conveyor means arranged or formed on the powder module provided for setting the powder module equipped with it in motion. Such a conveyor means can be, for example, an (electro)motive drive device integrated into a respective powder module. Thus, the freedom of movement of a powder module can be expanded since, for example, rotational movement around a vertical axis is possible.

Control of all movements of the powder modules moved in the system, especially in the tunnel structure, is performed via a central control device which purposefully communicates, e.g., radio-based, directly or indirectly with respective powder modules, which can be equipped with suitable communication devices for this purpose. In the central control device, all the information relevant to moving respective powder modules inside the system or tunnel structure is purposefully available, i.e., especially respective movement information, i.e., for example, speed information, respective position information, i.e., for example, start and destination information, respective prioritization information, etc. The movements of the powder modules in the system or tunnel structure can be controlled in a fully automated way.

A respective tunnel section limits at least one cavity in or through which at least one powder module can be moved. For the rest, the geometric structural design of a respective tunnel section is freely selectable, with the proviso that at least one powder module can be moved in or through it. A respective tunnel section can have, for example, a round, roundish, or square cross-sectional area. With regard to its length, a respective tunnel section can be formed at least sectionally, especially completely, straight or at least sectionally, especially completely, bent or curved. Of course, a respective tunnel section can be formed of several tunnel section segments, which are or can be connected with each other by forming the respective tunnel section.

A respective tunnel section can end in at least one more tunnel section, e.g., running parallel to it. The tunnel structure can—similar to a track or rail system known from rail traffic—comprise several tunnel sections ending in each other at defined positions. Several tunnel sections can run at least sectionally next to, on top of, or underneath each other. The tunnel structure can therefore comprise several tunnel sections running at least sectionally next to, on top of, or underneath each other, hence at different (horizontal and/or vertical) levels.

A respective tunnel section can be inertable, i.e., an inert atmospheres can be formed and maintained in it. Analogously, a certain pressure level, i.e., for example, positive or negative pressure, can be formed and maintained in a respective tunnel section. Therefore, the same applies to the entire tunnel structure.

For being connected with the tunnel structure, individual, several, or all workstations of the system can have a connecting section via which they are or can be connected with the tunnel structure. For example, the apparatus and/or demagnetization device can have at least one connecting section via which it is or can be connected with the tunnel structure. Hence, powder modules can, for example, be movable from the apparatus or demagnetization device into the tunnel structure or from the tunnel structure into the apparatus or demagnetization device.

Concretely, for example, powder modules with powder module components or carrying device components that are to be demagnetized can be moved, for example, from the apparatus or a storage station providing respective powder modules into the demagnetization device via the tunnel structure, be demagnetized there, and moved back, for example, into the apparatus via the tunnel structure.

The invention is explained in more detail by means of exemplary embodiments in the drawings. In which:

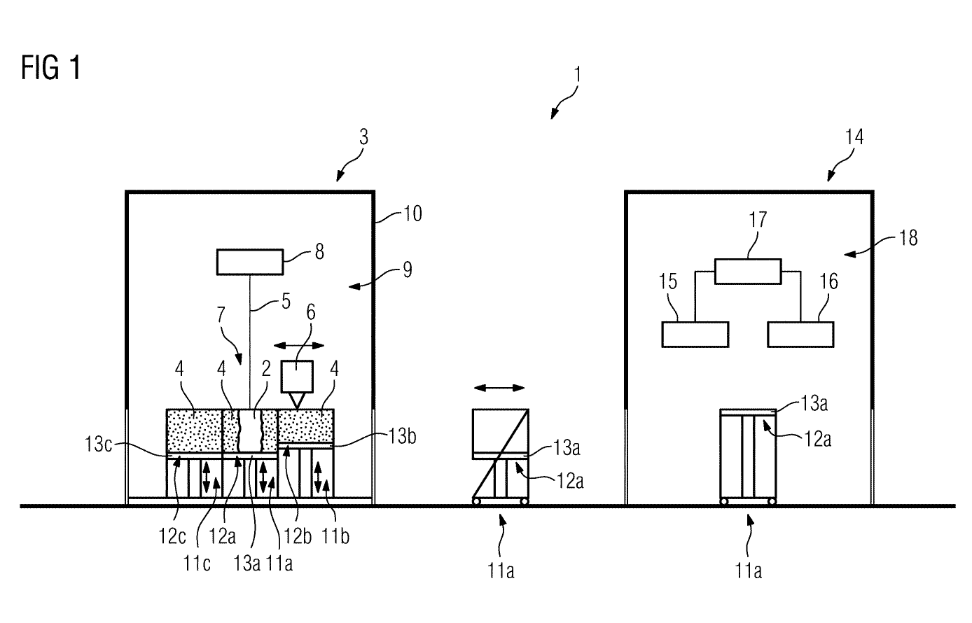

FIG. 1 shows a schematic diagram of a section of a system for additive manufacturing of three-dimensional objects according to an exemplary embodiment;

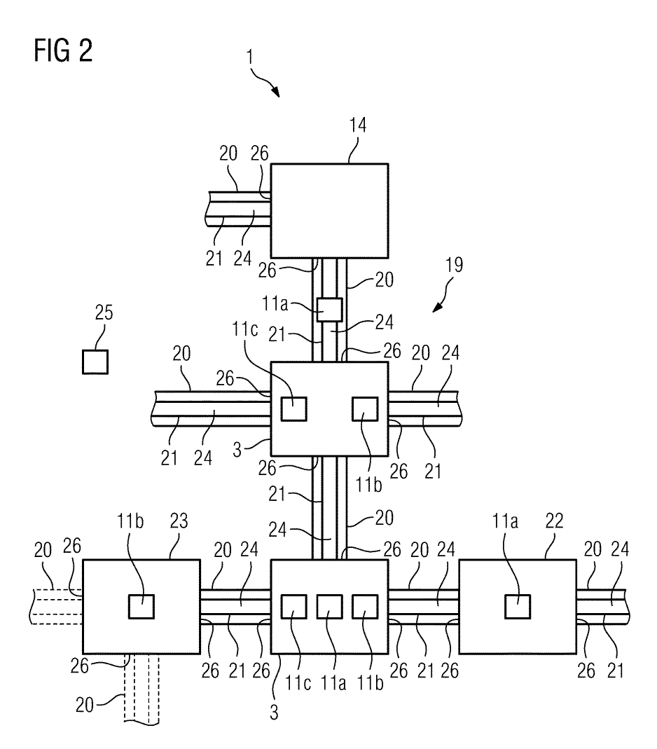

FIG. 2 shows a schematic diagram of a system for additive manufacturing of three-dimensional objects according to another exemplary embodiment.

FIG. 1 shows a schematic diagram of a section of a system 1 for additive manufacturing of three-dimensional objects 2, i.e., for example, technical components or technical component groups, according to an exemplary embodiment in a schematic side view.

The system 1 comprises an apparatus 3 (“construction or process station”) for additive manufacturing of three-dimensional objects 2 by successive, selective layer-by-layer exposure and thus solidification of individual construction material layers of a construction material 4 that can be solidified by means of an energy beam 5 (functional details of the apparatus 3 arise from FIG. 2). The construction material 4 that can be solidified can be, for example, a metal powder. The energy beam 5 can be a laser beam. The apparatus 3 can respectively be an apparatus for performing selective laser melting methods (SLM methods in short) or selective laser sintering methods (SLS methods in short). The system 1 can respectively be a system for performing selective laser melting methods (SLM methods in short) or selective laser sintering methods (SLS methods in short).

The apparatus 3 comprises all functional components required to perform additive construction processes. A respective component is an, as indicated by the horizontally oriented double arrow, movably supported coating device 6 for forming construction material layers to be selectively exposed in a construction plane 7 and an exposure device 8, for example, comprising one or more exposure elements (not shown) formed as or comprising laser diode elements, for generating an energy beam 5 for selective exposure of a construction material layer to be selectively exposed formed in the construction plane 7 by means of the coating device 6. The functional components are arranged in a housing structure 10 of the apparatus 3 defining a process chamber 9. The process chamber 9 can be rendered inert; therefore, an inert gas atmosphere, e.g., an argon atmosphere, and/or a certain pressure level can be formed and maintained in the process chamber 9.

The system 1 comprises several powder modules 11a-11c provided for receiving and/or dispensing construction material 4. The Fig. show the following powder modules 11a-11c: a construction module 11a in which the actual additive construction of three-dimensional objects 2 is performed and which is for this purpose filled successively and in layers with construction material 4 to be solidified selectively in the course of additive manufacturing processes, a metering module 11b via which construction material 4 is metered out into the process chamber 9 successively and in layers in the course of additive manufacturing processes, and a collector module 11c which is filled with construction material 4 that is not solidified in the course of additive manufacturing processes.

Every powder module 11a-11c comprises a powder chamber (not denoted in more detail) for receiving construction material 4 to be selectively solidified within the scope of an additive construction process or construction material 4 not solidified within the scope of an additive construction process. The powder chamber limits a powder chamber volume that can be filled with construction material. The powder chamber volume is limited at least on the sides by walls (powder chamber walls) of the powder chamber generally formed like a hollow cuboid or hollow cylinder. At the bottom, the powder chamber volume is limited by a carrying device 12a-12c.

Every carrying device 12a-12c is typically movably supported between two end positions, i.e., between an upper end position (related to the height of the powder module 11a-11c) and a lower end position (related to the height of the powder module 11a-11c), relative to the powder chamber. The movable support of the carrying devices 12a-12c allows for realizing a movement of the carrying devices 12a-12c along a vertical movement axis or in a vertical direction of movement indicated by the vertical double arrow. The movable support of the carrying devices 12a-12c is realized with a drive device (not denoted in more detail) coupled with the respective carrying device 12a-12c. The drive devices are provided for forming or generating a force (driving force) setting the respective carrying device 12a-12c in a respective motion relative to the powder chamber. The drive devices can, e.g., be formed (electro)mechanically, hydraulically, or pneumatically.

The carrying devices 12a-12c and thus the powder modules 11a-11c each comprise several components, Including, e.g., a table-like base body (not denoted in more detail) and one or more plate-like or plate-shaped supporting bodies 13a-13c arranged or formed, especially stack-like, on the base body. Respective supporting bodies 13a-13c can be functionalized differently. Respective supporting bodies 13a-13c can be, e.g., a construction plate, a heating plate, or a (thermal) insulating plate. One or more of the mentioned components of the carrying device 12a-12c, generally the powder module 11a-11c, are magnetizable, for example, because of being formed of a magnetizable material such as ferritic steel. A magnetizable component of the carrying device 12a-12c can especially but not necessarily be the mentioned construction plate.

Respective magnetizable components of the powder modules 11a-11c, i.e., especially the carrying devices 12a-12c, are magnetized under certain conditions especially during the operation of the system 1. Magnetization of the magnetizable components of the powder modules 11a-11c can, however, also be caused otherwise, i.e., for example, by the terrestrial magnetic field, i.e., especially by movements of the powder modules 11a-11c in the terrestrial magnetic field. To approach the related problem mentioned at the beginning, the system 1 comprises a demagnetization device 14. The demagnetization device 14 is provided for automatable or automated demagnetization of respective magnetized components of the powder modules 11a-11c. It is thus possible to perform demagnetization processes automatably or automatedly.

The demagnetization device 14 comprises a detection unit 15 provided for detecting the magnetization of a magnetized component of a powder module 11a-11c or a carrying device 12a-12c. The detection unit 15 is provided for generating detection information (detection result) describing the magnetization of the at least one magnetized component of the powder module 11a-11c, especially the carrying device 12a-12c. The detection unit 15 allows an exact detection of the magnetization, i.e., especially the (local or global) degree of magnetization, any (local or global) magnetization gradients, of a magnetized component. Knowledge of the magnetization of a magnetized component allows efficient demagnetization of the component. The detection unit 15 can be formed as a magnetometer (Gauss or Tesla meter).

The demagnetization device 14 furthermore comprises a demagnetization unit 16 provided for demagnetizing a magnetized component of a powder module 11a-11c, especially a carrying device 12a-12c. The demagnetization unit 16 is provided for performing at least one measure for demagnetization of a magnetized component of the powder module 11a-11c or carrying device 12a-12c. The measure is typically the generation of a demagnetizing field, i.e., a static or dynamic alternating magnetic field. The demagnetization unit 16 is therefore provided for generating a respective demagnetizing field and comprises the demagnetization elements (not shown) required for that, such as demagnetization coils.

The demagnetization device 14 furthermore comprises a control device 17 provided for controlling the operation of the at least one demagnetization unit 16 dependent on or on the basis of detection information describing the magnetization of the at least one magnetized component of the carrying device. The control device 17 implemented by hardware and/or software, data-coupled with the detection unit 15 and demagnetization unit 16, is provided with regard to a concrete magnetized component of a powder module 11a-11c or carrying device 12a-12c to be demagnetized individually generated control information, which allows for a particularly efficient demagnetization of the component to be demagnetized.

Obviously, the demagnetization device 14 comprises a receiving room 18 for receiving a powder module 11a-11c, i.e., especially a magnetized component of a powder module 11a-11c or carrying device 12a-12c to be demagnetized. In the receiving room 18, an inert atmosphere, especially an inert gas atmosphere, i.e., for example, an argon or nitrogen atmosphere, can be formed. The receiving room 18 can be magnetically shielded (outwards).

From the powder module 11a shown between the apparatus 3 and the demagnetization device 14 it can be seen that powder modules 11a-11c can be moved in or inside the system 1. Powder modules 11a-11c can therefore be moved, for example, to the demagnetization device 14 to demagnetize a component that is to be demagnetized. For moving the powder modules 11a-11c, these can be equipped, as shown in FIG. 1, for example, with wheels or rolls (not denoted in more detail). Analogously, it is, of course, also imaginable that the demagnetization device 14 is movable and can thus be moved in or inside the system 1.

The demagnetization device 14 is a workstation (demagnetization station) inside the system 1 provided with its own functionality namely the demagnetization of respective components of powder modules 11a-11c. Further workstations inside the system 1 are, for example, construction or process stations in which the actual additive manufacturing of the objects 2 is performed, unpacking stations 22 in which “unpacking” of additively manufactured objects 2 from the surrounding construction material 4 is performed, or filling stations 23 in which filling or emptying of respective powder modules 11a-11c is performed.

FIG. 2 shows a schematic diagram of a system 1 for additive manufacturing of three-dimensional objects 2, i.e., for example, technical components or technical component groups, according to another exemplary embodiment in a schematic top view.

From FIG. 2 it can be seen that respective powder modules 11a-11c can be moved back and forth between different workstations, which are stationary, i.e., unmovable, components of the system 1 typically firmly connected with a ground.

The system 1 comprises a tunnel structure 19. The tunnel structure 19 provides several tube-like or tube-shaped tunnel sections 20, in or through which the powder modules 11a-11c can be moved. In a respective tunnel section 20, at least one movement path 21 is formed or arranged along which a powder module 11a-11c can be moved through the tunnel section 20. In a tunnel section 20, at least sectionally several movement paths 21 can be formed or arranged, i.e., for example, movement paths 21 arranged adjacently, especially in parallel, at one or more level(s). A respective movement path 21 allows guided movement of a powder module 11a-11c in or through the respective tunnel section 20. The tunnel sections 20 can be inertable, i.e., an inert atmosphere, a certain pressure level, i.e., for example, positive or negative pressure, can be formed and maintained in them.

The function of the tunnel structure 19 or the associated tunnel sections 20 is to connect different workstations of the system 1, i.e., for example, construction or process stations (apparatuses 3) and, for example, the demagnetization station (demagnetization device 14), directly or indirectly, i.e., for example, by interconnecting at least one more tunnel section 20 and/or one more workstation of the system 1. The connection of respective workstations of the system 1 allows for moving back and forth respective powder modules 11a-11c between respective workstations of the system 1. Moving respective powder modules 11a-11c through the tunnel structure 19 is possible in a fully automated way.

For moving respective powder modules 11a-11c, the system 1 comprises a conveyor device 24 coupled with a (motorized) drive device (not shown) via which a driving force can be generated that sets a powder module 11a-11c in motion. The conveyor device 24 can comprise a conveyor means (not shown) arranged or formed on the tunnel structure provided for setting a powder module 11a-11c in motion. The conveyor means can, for example, be a mechanical conveyor means, i.e., for example, a belt, chain, or roll conveyor, which defines, due to its extension inside a respective tunnel section 20, a conveyor line and thus the movement path 21 along which a powder module 11a-11c can be moved. A respective conveyor means can, for example, be arranged or formed on the floor or wall of a tunnel section 20.

It is also imaginable that the conveyor device 24 comprises respective conveyor means arranged or formed on the powder module provided for setting the powder modules 11a-11c equipped with it in motion. Such a conveyor means can be, for example, an (electro)motive drive device integrated into a respective powder module 11a-11c. Thus, the freedom of movement of a powder module 11a-11c can be expanded since, for example, rotational movement around a vertical axis is possible.

The movement path of one or more powder module(s) 11a-11c between respective workstations of the system 1 can be chosen on the basis of certain prioritizations of certain powder modules 11a 11c. For higher-prioritized powder modules 11a-11c, shorter movement paths 21 as regards distance or time can be chosen than for lower-prioritized powder modules 11a-11c.Similarly, higher-prioritized powder modules 11a-11c can be moved with a higher speed compared to lower-prioritized powder modules 11a-11c.

All movements of the powder modules 11a-11c in the tunnel structure 19 are controlled via a central control device 25 which purposefully communicates, e.g., radio-based, directly or indirectly with respective powder modules 11a-11c, which can be equipped with suitable communication devices (not denoted in more detail) for this purpose. In the central control device 25, all the information relevant to moving respective powder modules 11a-11c inside the tunnel structure 19 is available, i.e., especially respective movement information, i.e., for example, speed information, respective position information, i.e., for example, start and destination information, respective prioritization information, etc. The movements of the powder modules 11a-11c in the tunnel structure 19 can be controlled in a fully automated way.

For being connected with the tunnel structure 19, the workstations of the system 1 each provide at least one connecting section 26 via which they are or can be connected with the tunnel structure 19. The connecting section 26 represents an entry or exit area from the respective workstations of the system 1 into the tunnel structure 19 and from the tunnel structure 19 into the respective workstations.

Although not shown in the Figures, tunnel sections 20 of the tunnel structure 19 can also be arranged or formed in respective workstations of the system 1, i.e., for example, in the apparatus 3 or in the demagnetization device 14, which communicate with a tunnel section 20 arranged or formed outside the respective workstation of the system 1 via respective connecting sections 26. The tunnel structure 19 can hence (also) extend through respective workstations of the system 1.

1. A system (1) for additive manufacturing of three-dimensional objects, comprising:
at least one apparatus (3) provided for additive manufacturing of a three-dimensional object (2) by successive, selective layer-by-layer exposure and thus solidification of construction material layers to be selectively solidified by means of an energy beam (5),
at least one powder module (11a-11c) comprising a powder chamber limiting a powder chamber volume for receiving construction material (4) to be solidified within the scope of an additive construction process or not solidified within the scope of an additive construction process with a carrying device (12a-12c) arranged or formed therein comprising at least one magnetizable component, characterized by
at least one demagnetization device (14) provided for automatable or automated demagnetization of at least one magnetized component of the powder module (11a-11c), especially the carrying device (12a-12c).

2. A system according to claim 1, characterized in that the demagnetization device (14) comprises at least one detection unit (5) provided for detecting magnetization of a magnetized component of the powder module (11a-11c), especially the carrying device (12a-12c).

3. A system according to claim 2, characterized in that the detection device (15) is formed as or comprises a magnetometer.

4. A system according to claim 1, characterized in that the demagnetization device (14) comprises at least one demagnetization unit (16) provided for demagnetizing the at least one magnetized component of the powder module (11a-11c), especially the carrying device (12a-12c).

5. A system according to claim 4, characterized in that the demagnetization unit (16) is provided for generating a demagnetizing field, especially an alternating magnetic field.

6. A system according to claim 2, characterized by a control device (17) provided for controlling the operation of the at least one demagnetization unit (16) dependent on detection information describing the magnetization of the at least one magnetized component of the powder module (11a-11c), especially the carrying device (12a-12c).

7. A system according to claim 1, characterized in that the demagnetization device (14) comprises a receiving room (18) for receiving a magnetized component of the powder module (11a-11c) to be demagnetized, especially the carrying device (12a-12c), wherein an inert atmosphere is or can be formed in the receiving room (18).

8. A system according to claim 1, characterized in that the powder module (11a-11c) can be moved inside the system (1), especially between the apparatus (3) and the demagnetization device (14) and vice versa.

9. A system according to claim 1, characterized by a tunnel structure (19) having at least one tunnel section (20) in which at least one powder module (11a-11c) can be moved, wherein
the at least one apparatus (3) has at least one connecting section (26) via which the apparatus (3) is or can be connected with the tunnel structure (19) such that a powder module (11a-11c) can be moved from the apparatus (3) into the tunnel structure (19) or from the tunnel structure (19) into the apparatus (3), and/or
the at least one demagnetization device (14) has at least one connecting section (26) via which the apparatus (3) is or can be connected with the tunnel structure (19) such that a powder module (11a-11c) can be moved from the demagnetization device (14) into the tunnel structure (19) or from the tunnel structure (19) into the demagnetization device (14).

10. A system according to claim 9, characterized by a conveyor device (24) for conveying at least one powder module (11a-11c) inside the tunnel structure (19), wherein the conveyor device (24) comprises at least one conveyor means arranged or formed on the tunnel structure, provided for setting a powder module (11a-11c) in motion, and/or comprises at least one conveyor means arranged or formed on the powder module, provided for setting a powder module (11a-11c) in motion.
